(19) United States
(12) Patent Application Publication
(10) Pub. No.: US 2010/0317371 A1
(43) Pub. Date: Dec. 16, 2010

(54) CONTEXT-BASED INTERACTION MODEL FOR MOBILE DEVICES

(76) Inventors: William J. Westerinen, Issaquah, WA (US); Miller T. Abel, Mercer Island, WA (US); Charles J. Migos, San Bruno, CA (US)

Correspondence Address: VIERRA MAGEN/MICROSOFT CORPORATION, 575 MARKET STREET, SUITE 2500, SAN FRANCISCO, CA, 94105, US

(21) Appl. No.: 12/483,492

(22) Filed: Jun. 12, 2009

(51) Int. Cl. H04W 64/00

(52) U.S. Cl. 455/456.6

(57) ABSTRACT

A context-aware mobile device such as a cell phone automatically determines appropriate user interface (UI) settings to implement at different times and/or locations. A behavior of the mobile device is tracked by determining locations visited and UI settings which are manually configured by the user. Patterns in the movement and UI settings relative to one another and to time are detected. When a particular location or time is subsequently reached which corresponds to the pattern, an appropriate UI setting can be implemented, thereby relieving the user of this task. Locations can be detected by electromagnetic signals at different locations, such as from a Wi-Fi network, Bluetooth network, RF or infrared beacon, or a wireless point-of-sale terminal. An identifier from the signals such as an SSID can be stored. Labels for locations can be automatically assigned, or the user can be prompted to provide a label for commonly visited locations.

### BACKGROUND

Cellular telephones are mobile communication devices which have become omnipresent in society. In addition to providing voice communications and other data communications such as web browsing, mobile devices typically have a number of built in applications such as calendar scheduling applications which can provide reminder notifications at specified times. However, significant burdens are imposed on the user of the mobile device to configure the device to fit the user's needs. For example, various behaviors of the device can be configured such as ringer and other notification settings, call forwarding settings, and other settings. Failure to configure a particular setting at a particular time and place can result in inconvenience, embarrassment, missed communications or other problems for the user.

### SUMMARY

A context-aware mobile device which communicates by wireless signals is provided, in addition to a processor-implemented method for controlling such a mobile device.

The mobile device may be a hand-held mobile device such as a cell phone, web-enabled smart phone, personal digital assistant, palmtop computer, laptop computer or similar device which communicates by wireless signals. The mobile device periodically senses wireless signals at different locations which are visited and stores user interface (UI) settings which are manually set by the user. The different locations can be a user's home, a work place, a coffee shop and so forth. The mobile device can determine that it is at a certain location by sensing wireless signals from a Wi-Fi network, Bluetooth network, RF or infrared beacon, or a wireless point-of-sale terminal, for instance, and storing identifiers associated with the signals. The UI settings can relate to notification settings, such as audible and visual alerts, call forwarding settings, and other settings. Patterns in the movement and UI settings relative to one another and to time are then identified. For example, a pattern may be detected in which the mobile device visit a certain coffee shop five days a week at 8:30am, where the user sets the ringer to a silent mode when arriving at the coffee shop. When a particular location or time is subsequently reached which corresponds to the pattern, an appropriate UI setting can be implemented, thereby relieving the user of this task. For example, when the user visits the coffee shop a subsequent time, the mobile device can automatically configure itself with the ringer in the silent mode.

In one embodiment, a processor-implemented method for controlling a context-aware mobile device which communicates by wireless signals is provided. The method includes tracking movement of the mobile device by having the mobile device sense electromagnetic radiation, e.g., a wireless RF signal, which is present at different locations visited by the mobile device, and storing location-identifying information associated with the electromagnetic (EM) radiation at each location. The method further includes identifying a pattern in the movement of the mobile device based on the tracking of the movement. For example, the pattern may indicate that a user visits a particular location regularly at certain times. User interface settings of the mobile device are tracked by storing a user interface setting of the mobile device, cross referenced to the location-identifying information, when the mobile device is present at the different locations, and identifying a pattern in the user interface settings of the mobile device relative to the different locations based on the tracking of the user interface settings. The method further includes, automatically, without user intervention, modifying the user interface setting of the mobile device, based on the pattern in the movement of the mobile device and the pattern in the user interface settings of the mobile device. For example, the ringer may be automatically turned off when the mobile device enters a certain location.

This summary is provided to introduce a selection of concepts in a simplified form that are further described below in the description. This summary is not intended to identify key features or essential features of the claimed subject matter, nor is it intended to be used to limit the scope of the claimed subject matter.

### BRIEF DESCRIPTION OF THE DRAWINGS

FIG. 1 depicts a mobile device which passes through different electromagnetic fields at different locations.

FIG. 2a depicts a mobile device which determines a location from GPS signals from satellites.

FIG. 2b depicts a mobile device which determines a location from GSM signals from cell phone antennas.

FIG. 3a depicts a mobile device which senses wireless RF signals in a Wi-Fi network.

FIG. 3b depicts a mobile device which senses wireless RF signals in a Bluetooth network.

FIG. 3c depicts a mobile device which senses wireless RF signals from a video game controller and console.

FIG. 3d depicts a mobile device which senses wireless RF signals from beacons.

FIG. 3e depicts a mobile device which senses infrared signals at a point-of-sale terminal.

FIG. 4 depicts a block diagram of a mobile device.

FIG. 5 depicts a mobile device network.

FIG. 6 depicts a process for tracking a mobile device.

FIG. 7 depicts tracking of location-identifying information by a mobile device.

FIG. 8 depicts tracking of user interface settings by a mobile device.

FIG. 9 depicts a process for automatically configuring user interface settings of a mobile device based on time.

FIG. 10 depicts a process for automatically configuring user interface settings of a mobile device based on location.

FIG. 11 depicts a process for sensing electromagnetic radiation at different time intervals.

FIG. 12 depicts a process for automatically configuring user interface settings of a mobile device based on motion sensing.

FIG. 13 depicts a process for automatically generating a label for a location, or prompting a user to input a label.

FIG. 14a depicts a user interface of a mobile device which prompts a user to enter a label for a location.

FIG. 14b depicts a user interface of a mobile device which automatically determines a label for a location, and prompts a user to ratify the label.

FIG. 14c depicts a user interface of a mobile device which informs a user of a current user interface profile.

FIG. 14d depicts a user interface of a mobile device which informs a user of details of a current user interface profile.

FIG. 15a depicts an example sequence of events of a user in a day, with corresponding location data and manually-configured user interface settings.

FIG. 15b depicts a listing of location identifiers versus time from the example sequence of events of FIG. 15a.

FIG. 15c depicts a listing of manually-configured user interface settings versus location identifiers from the example sequence of events of FIG. 15a.

FIG. 15d depicts a listing of manually-configured user interface settings versus time from the example sequence of events of FIG. 15a.

FIG. 15e depicts an example sequence of events of a user in a day, with corresponding location data and automatically-configured user interface settings, based on he sequence of FIG. 15a.

FIG. 16 depicts an example block diagram of computer hardware suitable for implementing various embodiments.

### DETAILED DESCRIPTION

A context-aware mobile device which communicates by wireless signals is provided, in addition to a processor-implemented method for controlling such a mobile device. Conventionally, a mobile device does not have the ability to learn the habits of a user, so the device must be manually configured by the user to change its behavior to one which is suitable for the current context of the device. The user must configure the device based on the current location and/or time. For example, when attending an event such a religious service, the user will typically turn off the ringer beforehand so that incoming phone calls, text messages, calendar notifications, alarms and the like will not result in an embarrassing audible notification. This imposes a burden on the user. Likewise, the user must reconfigure the device to turn the ringer back on after leaving the event or the user may miss an incoming message.

A context-aware mobile device and a method for controlling such a mobile device can overcome these problems by tracking the use of a mobile device over a period of time, such as days or weeks, and detecting patterns in the usage. The tracking can identify regular functions which are performed by the mobile device on a repeating basis, at one or more locations. This may involve using various capabilities of a device which are typically already present in modern mobile devices, such as calendar, clock and location detectors, with additional functionalities added by software or firmware updates such as in the operating system. In some cases, additional hardware is added as well. After learning the user's habits, the mobile device can automatically modify its settings based on a user profile, time of day, and location, for instance. This allows the mobile device to automatically change its behavior throughout the day at different locations, without user intervention.

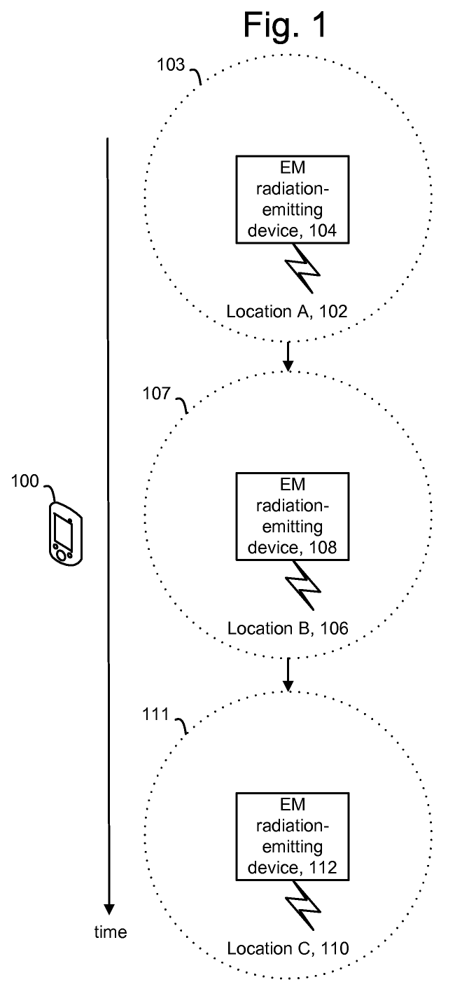

FIG. 1 depicts a mobile device which passes through different electromagnetic fields at different locations. Electromagnetic (EM) radiation, such as wireless radio frequency (RF) signals and infrared signals, is present at many locations a mobile device visits. Sometimes the EM radiation is emitted by a source at a location and sometimes it is emitted from outside the location. Sometimes multiple types of EM radiation are present at the same location. EM radiation may travel over relatively long distances, such as EM radiation from Global Positioning System (GPS) satellites in the microwave band and from cellular phone antennas in the ultra high frequency (UHF) band. UHF is also used for Wi-Fi (IEEE 802.11) and Bluetooth (IEEE 802.15.1) transmissions. For example, a first EM radiation-emitting device 104 may emit signals in a location A (102), over a range 103, a second EM radiation-emitting device 108 may emit signals in a location B (104), over a range 107, and a third EM radiation-emitting device 112 may emit signals in a location C (110), over a range 111. The ranges can differ. A mobile device 100 which is carried by a user may travel through the radiation fields of the different locations at different times. Furthermore, in visiting the different locations, the mobile device may or may not associate to an EM signal. That is, the presence of an EM signal can be passively detected without connecting to a network which provides the signal. An EM signal can also be detected with fully decoding the signal. The mere presence of the signals can be used to gain important clues about the current context of the mobile device. However, optionally, in some cases the mobile device can associate to the EM signal. Associating with a network which provides the signal reduces the security threat of someone trying to spoof a location. Moreover, networks such as Bluetooth and Wi-Fi have both secured and unsecured forms, either of which could be used.

While a mobile device typically includes a cell phone capability, other communication technologies such as Wi-Fi, Bluetooth and IRDA (Infrared Data Association) exist and are currently incorporated into many mobile devices. These technologies allow voice and other data communications. Mobile devices generally can include cell phones (including web-enabled smart phones), personal digital assistants (PDAs)/palmtop computers, portable media players (e.g., MICROSOFT ZUNE®, APPLE IPOD®), laptop computers such as net books, and other devices.

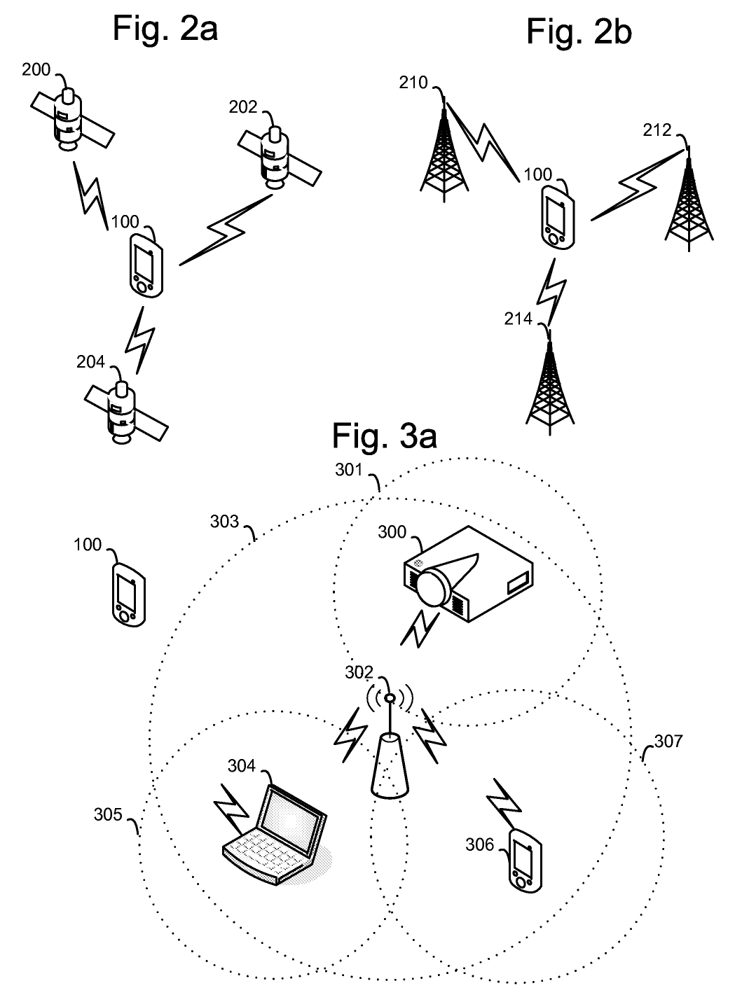

FIG. 2a depicts a mobile device which determines a location from GPS signals from satellites. The mobile device 100 can determine its location within a few meters in some cases using GPS signals from three or more satellites, such as example satellites 200, 202 and 204, depending on various factors such as atmospheric conditions, time at a location and so forth. The determined location is typically provided by latitude, longitude coordinates.

While the location which is determined from GPS signals can be used to configure user interface (UI) settings of a mobile device, GPS signals can yield other valuable information for configuring UI settings. This other information includes which direction a mobile device is moving, how fast it is moving, and whether it moving up or down in altitude. These pieces of information can all be used to build additional situation awareness without trying to make sense of the specific location itself. That is, determining that a location of the mobile device has changed is useful, even if the location itself is not known. For example, if a change in location of mobile device indicates it is moving at 50 miles per hour, it can be concluded heuristically that the user is in a motorized vehicle and is not walking. If the mobile device is increasing in altitude at a rate of ten meters per second, it is likely in an elevator. An appropriate UI setting can be a function of these types of information. For instance, when in a motorized vehicle, a ringer volume may be automatically set louder to overcome road noise, or the ringer may be set off to avoid a distraction. Similarly, when in an elevator, a ringer may be set to a low volume as the interior of an elevator is normally quiet.

FIG. 2b depicts a mobile device which determines a location from Global System for Mobile communication (GSM) signals from cell phone antennas. GSM is the most popular standard for cell phones in the world, and is one example of a possible cell phone communication protocol. Universal Mobile Telecommunications System (UMTS) is another cell phone communication protocol. As with GPS, cell phone signals can similarly be used to identify a location. The accuracy depends on the cell size. For a large cell, the accuracy may be less than that of GPS, e.g., within about fifty meters. Accuracy of smaller cells can be similar or better than that of GPS. Identifying a location using cell phone signals can include measuring power levels and antenna patterns of cell phone antennas, and interpolating signals between adjacent antenna towers. The mobile device 100 can determine its location using signals from example antennas 210, 212 and 214. The determined location can be provided, e.g., by latitude, longitude coordinates, or by an identifier of a cell antenna.

In the GSM standard, there are five different cell sizes with different coverage areas. In a macro cell, the base station antenna is typically installed on a mast or a building above average roof top level and provides coverage over a couple of hundred meters to several tens of kilometers. In a micro cell, typically used in urban areas, the antenna height is under average roof top level. A micro cell typically is less than a mile wide, and may cover a shopping mall, a hotel, or a transportation hub, for instance. Picocells are small cells whose coverage diameter is a few dozen meters, and are mainly used indoors. Femtocells are smaller than picocells, and are designed for use in residential or small business environments and connect to a service provider's network via a broadband internet connection. Umbrella cells are used to cover shadowed regions of smaller cells and fill in gaps in coverage between those cells. The cell horizontal radius varies depending on antenna height, antenna gain and propagation conditions. Indoor coverage can be achieved by using an indoor picocell base station, or an indoor repeater with distributed indoor antennas fed through power splitters, to deliver the radio signals from an antenna outdoors to the separate indoor distributed antenna system. These are typically deployed when a large call capacity is needed indoors, for example in shopping centers or airports.

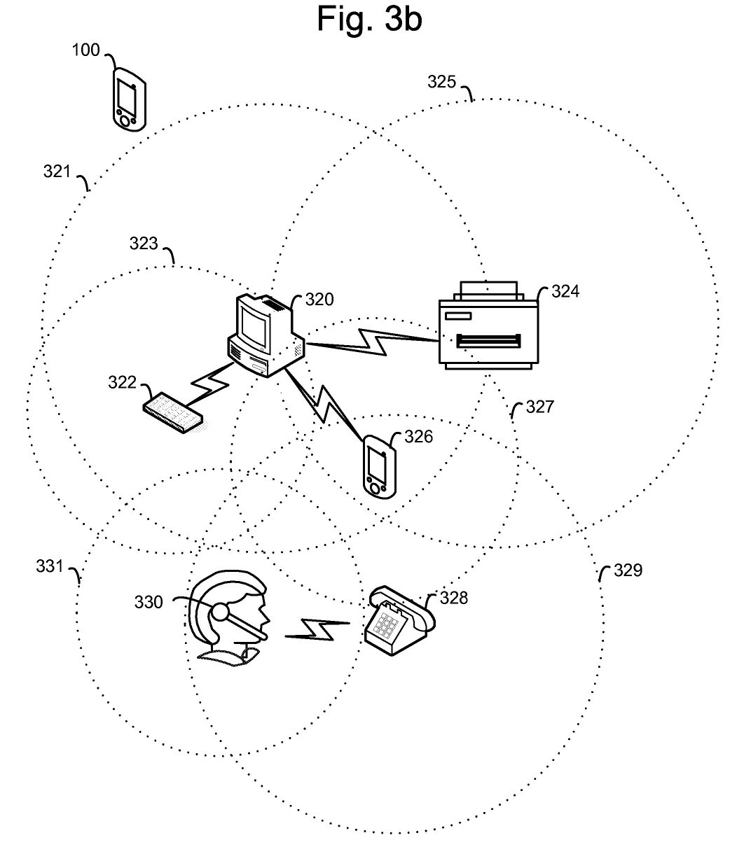

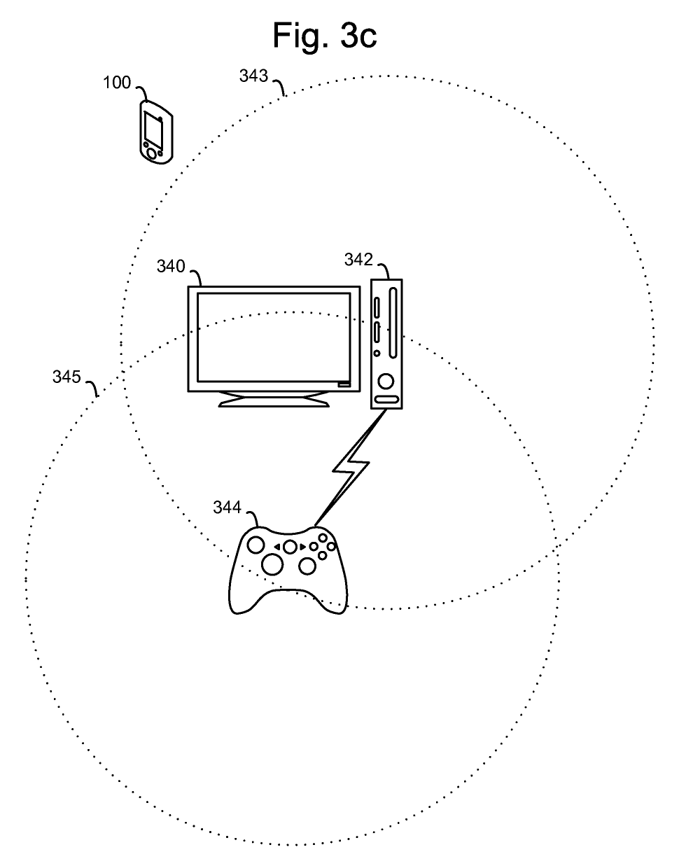

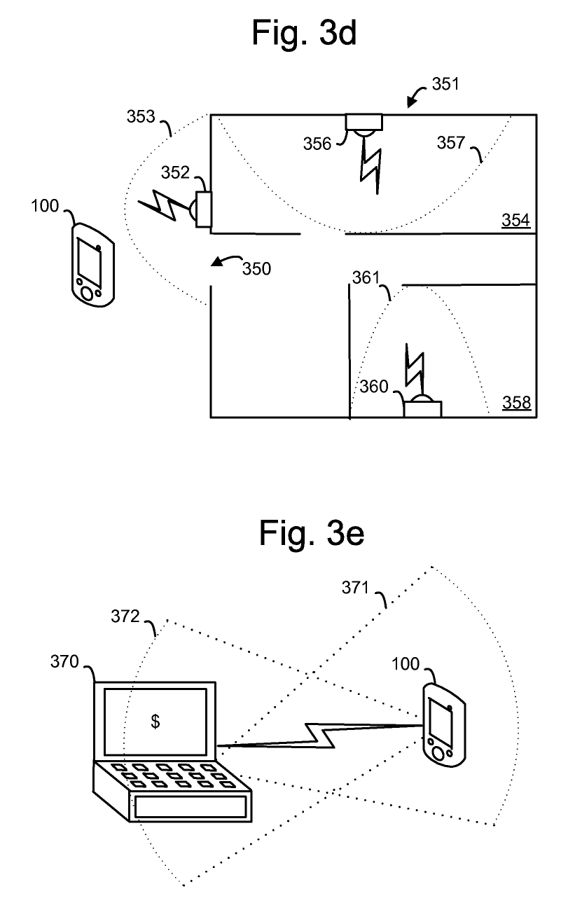

FIG. 3a depicts a mobile device which senses wireless RF signals in a Wi-Fi network. Wi-Fi® is a certification of the Wi-Fi Alliance® for certified products based on the IEEE 802.11 standard, and ensures interoperability between different wireless devices. Wi-Fi is a type of wireless local area network (WLAN). This example includes an access point 302 and client devices such as a wireless projector 300, laptop computer 304 and additional cell phone 306. Wi-Fi networks are increasingly deployed in various locations such as office buildings, universities, retail establishments such as coffee shops, restaurants, and shopping malls, as well as hotels, public spaces such as parks and museums, airports, and so forth.

The access point 302 broadcasts a message over a range 303 which advertises its service set identifier (SSID), which is an identifier or name of the particular WLAN. The SSID can be a set of bits with any value but is typically a string of ASCII characters which can be displayed to the user. The SSID is an example of a signature of an EM signal. The signature is some characteristic of a signal which can be obtained from the signal, and which can be used to identify the signal when it is sensed again. A Wi-Fi network can have a range of several meters to much longer distances. Examples of Wi-Fi enabled devices include cell phones, personal computers (PCs), game consoles, portable media players and PDAs. The client devices transmit signals to the access point 302 over respective ranges which can differ from that of the access point 302. For example, the wireless projector 300 transmits over a range 301, the laptop computer 304 transmits over a range 305, and additional cell phone 306 transmits over a range 307. The mobile device 100 can detect wireless signals from the access point 302 or from any of the client devices.

In particular, the SSID is carried in a BEACON management message from the access point 302 several times per second. The BEACON also contains the time, capabilities, supported data rates, and physical layer parameter sets that regulate the operation of the network. When a client station connects to an access point, it sends either an ASSOCIATION or REASSOCIATION message which contains the SSID. The device 100 can detect the presence of these messages by passive scanning of a known range of the wireless channels (e.g., 2.402 to 2.480 GHz in the North America). A packet analyzer/sniffer may be used for such scanning. It is also possible for the device to detect the presence of EM radiation in the channels by the amount of signal power, without decoding the SSID or other portions of the signals.

The access point 302 is typically stationary and permanently installed at a location, while the client devices can be highly mobile or stationary. For example, the projector 300 may be relatively stationary, kept in a conference room in an office building, in which case a signal which is emitted from the projector can be associated with the conference room with a relatively high probability. Moreover, the laptop computer 304 and cell phone 306, even though they are highly mobile, may be associated with a particular location at a particular time, if the user carries the devices to the particular location at the particular time on a repeated and reliable basis.

Regarding the Wi-Fi projector 300, it will have a certain kind of transmit and receive packet activity which can easily be detected by packet sniffing software that could be deployed into a mobile device with a Wi-Fi capability. This allows the mobile device to recognize a signal as being from that projector and knowing that it is in the conference room, say on the second floor in a particular building. Also, it might be known, say, that it is 10 am on a Tuesday and the calendar shows a certain event is scheduled in the conference room. These pieces of information add up to provide a picture of where the user is and why he or she is there, or at least that he or she is repeating a behavior or engaging in a new behavior. The projector 300 is an example of a surveyed device which has an asset tag, so its location is known as well as its network address such as an IP address. Access points and other pieces of infrastructure are deployed to known locations and have describable network characteristics that are stable in some form.

The wireless access point 302 connects one or more wireless devices to an adjacent wired LAN, e.g., including an Ethernet hub or switch. The access point may also be part of a wireless router or a wireless network bridge. Extenders or wireless repeaters can extend the range of an existing wireless network. The client devices 300, 304 and 306 include wireless adapters which allow them to connect to the wireless network.

FIG. 3b depicts a mobile device which senses wireless RF signals in a Bluetooth network. Bluetooth (IEEE 802.15.1) is an open wireless protocol for exchanging data over short distances from fixed and mobile devices, creating personal area networks (PANs). It is intended as a replacement for cabling in a variety of personally carried applications, including: (a) replacement of traditional wired serial communications in test equipment, GPS receivers, medical equipment, bar code scanners, and traffic control devices, (b) for controls where infrared was traditionally used, (c) for low bandwidth applications where cable-free connection is desired, (d) for wireless game consoles, (e) for modems used to transfer data such as files to handheld computers (e.g., PDAs) using a communications protocol such as OBject EXchange (OBEX) (OBEX can also be used for infrared communications) and (f) for headsets used to transfer sound data with telephones. Bluetooth uses the same radio frequencies as Wi-Fi, but typically with lower power.

In an example scenario, the mobile device 100 may sense EM radiation from a number of devices which are present in an office environment, including a PC 320 which communicates in a range 321 with a wireless keyboard 322, a wireless printer 324 and another mobile device 326 such as a PDA. Similarly, the wireless keyboard 322 transmits in a range 323, the wireless printer 324 transmits in a range 325, and the mobile device 326 transmits in a range 327. Further, a landline telephone 328 transmits in a range 329 to communicate with a wireless headset 330 which transmits in a range 331. Thus, as the mobile device 100 visits a location which has the Bluetooth compatible items, it senses Bluetooth RF signals.

FIG. 3c depicts a mobile device which senses wireless RF signals from a video game controller and console. Many game consoles and controllers, such as used in the MICROSOFT XBOX® and NINTENDO Wii® use RF signals to communicate with one another. Bluetooth or other protocols are typically used. Here, a game console 342 communicates with a wireless controller 344 using RF signals. The game console 342 transmits in a range 343 while the wireless controller 344 transmits in a range 345. A television or other monitor 340 communicates with the console 342 to display images. Thus, as the mobile device 100 visits a location such as a home which has the RF transmitting items which are shown, for instance, it can sense the RF signals. Some older technology video game consoles and controllers use infrared signals to communicate and it is also possible for the mobile device 100 to sense these signals as well. Infrared signals are also used for television remote controls and set-top boxes. When such signals are detected by a mobile device, it can be concluded that the mobile device is in a location of the game controller, console, TV remote, set-top box or other device, such as in the living room or game room of a home. This information can be used to set UI settings automatically.

FIG. 3d depicts a mobile device which senses wireless RF signals from beacons. Beacons which transmit RF or infrared signals can be used in networks such as wireless LANs to monitor the location or movement of people and goods, and to provide location-specific information to users. Beacons provide active signals that are unique to the location of the beacon. In an example scenario, a beacon 352 transmits over a range 353 and is at an entrance 350 to a building 351. A beacon 356 transmits over a range 357 and is in a room 354 in the building 351. A beacon 360 transmits over a range 361 and is in a room 358 in the building 351. Thus, as the mobile device 100 visits the different locations around the building, it can sense the signals from the different beacons.

In monitoring the location and movement of goods, beacons can be installed in different locations of a warehouse, hospital, office or other location. The beacons can periodically transmit signals which activate the Radio Frequency Identification (RFID) tags that are attached to goods or equipment, for instance. The mobile device 100 can also sense the wireless signals from such beacons. In providing location-specific information, for example, the beacon transmits a signal over a relatively small range, such as within a room. The signal includes an identifier which is unique to each beacon, and which can be correlated with a location, typically within a building. By sensing the signals, the mobile device 100 can determine its location and access an application to obtain location-specific information. For example, in a healthcare setting, a user can obtain information which identifies the closest location of certain medical equipment. In an office setting, a user can obtain information which identifies the closest location of a resource such as a printer.

FIG. 3e depicts a mobile device which senses infrared signals at a point-of-sale (POS) terminal. Technologies have been developed to provide wireless POS terminals which allow a user to conduct a transaction, such as to pay for goods or services, using a mobile device such as a cell phone or PDA. RF technology such as Bluetooth and infrared technology such as IRDA can be used to provide wireless communications between a POS terminal 370 and the mobile device 100. In this example, the POS terminal 370 transmits infrared signals in a range 371, and the mobile device 100 transmits infrared signals in a range 372. Infrared transmissions are normally directional. When the mobile device 100 communicates with the POS terminal 370, it can obtain an identifier which it can associate with a location of the terminal.

IRDA is a communications protocol for short range exchange of data over infrared light such as for use in personal area networks. Infrared signals can also be used between game controllers and consoles and for TV remote controls and set top boxes. IrDa, infrared signals generally, and optically signals generally, may be used.

The POS terminal 370 may be attended by a clerk, such as where the terminal is a cash register for a grocery store, retail establishment or restaurant, or the terminal may be unattended. For example, unattended wireless POS terminals can be used to pay parking fees, pay public transit fees and enter a tollgate such as in a subway, purchase items from a vending machine, buy tickets to a show at a kiosk, or purchase gasoline at a pump. Shopping malls, arenas, grocery stores, restaurants, and other retail areas can be configured with wireless terminals to allow customers to perform financial transactions throughout the building. Along with electronic payment, related transactions could occur involving, e.g., discounts, electronic coupons, customer loyalty benefits and so forth. Industry bodies which are developing standards for the secure transmission, storage, and format of electronic financial instruments via wireless terminals include: Infrared Data Association's (IRDA) Infrared Financial Messaging Special Interest Group (IRFM SIG), Mobile Electronic Transaction Forum (MeT Forum), the Bluetooth Special Interest Group's (Bluetooth SIG) Short Range Financial Transaction Study Group (SRFT SG), and the National Retail Federation (NRF).

Medical applications of wireless terminals includes remote patient monitoring, obtaining wireless biometric data, and dispensing medicine. In the travel industry, a wireless terminal can be used to allow a traveler to check in for a flight using a mobile device. Many other applications are possible.

Moreover, in addition to detection of wireless EM signals, signals may be detected by the mobile device via a wired path. For example, a mobile device which is plugged into a AC powered battery charger which charges a battery in the mobile device could receive location-identifying signals which are transmitted through the home wiring while the mobile device is being charged. Power line communication technologies can be used in this approach. Power line communications are used to interconnect home computers, peripherals or other networked consumer peripherals. Proprietary specifications for power line home networking are provided, e.g., by the HomePlug Powerline Alliance, the Universal Powerline Association and the HD-PLC Alliance. Or, the mobile device could receive location-identifying signals when connected to a laptop or PC to be recharged or to transfer data, e.g., via a USB connection.

For example, consider a user that returns home in the evening, turns the ringer of the mobile device off and plugs the mobile device into a charger. The mobile device remains powered on such as to synchronize email from another device and perform other tasks. The mobile device can learn to automatically configure UI settings by turning the ringer off when it is plugged into the charger, or otherwise undergoes charging, such as by placement on a power mat which charges by magnetic induction.

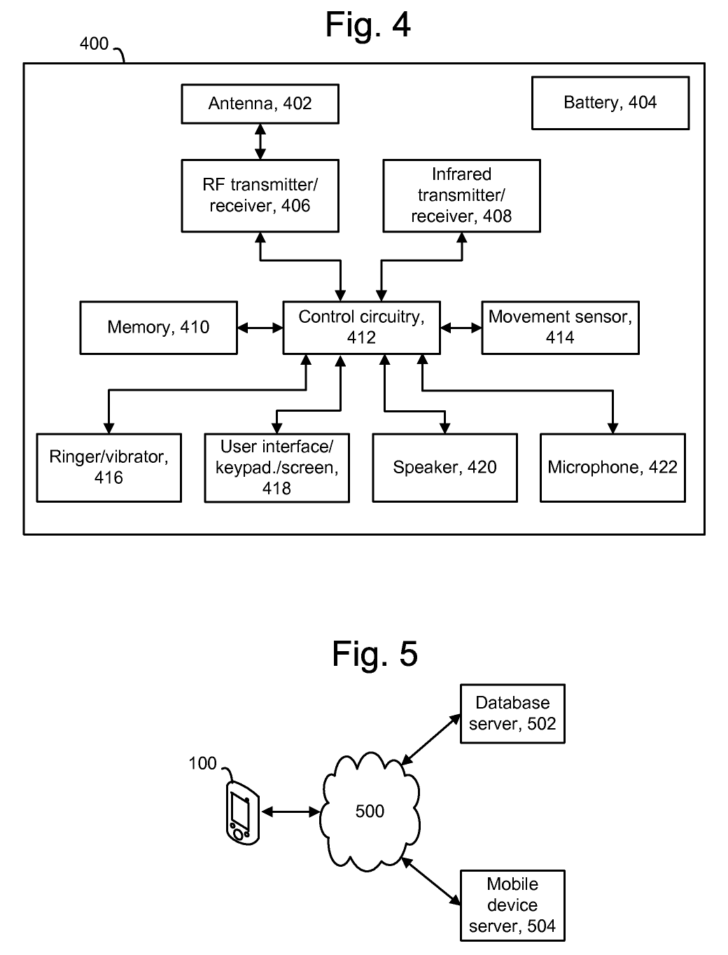

FIG. 4 depicts a block diagram of a mobile device 400. Exemplary electronic circuitry of a typical cell phone is depicted. The circuitry includes control circuitry 412 that can include one or more microprocessors, and storage or memory 410 (e.g., non-volatile memory such as ROM and volatile memory such as RAM) which stores processor-readable code which is executed by one or more processors of the control circuitry 412 to implement the functionality described herein. The control circuitry 412 also communicates with RF transmit/receive circuitry 406 which in turn is coupled to an antenna 402, with an infrared transmitted/receiver 408, and with a movement sensor 414 such as an accelerometer. Accelerometers have been incorporated into mobile devices to enable such applications as intelligent UIs that let users input commands through gestures, indoor GPS functionality which calculates the movement and direction of the mobile device after contact is broken with a GPS satellite, and to detect the orientation of the device and automatically change the display from portrait to landscape when the phone is rotated. An accelerometer can be provided, e.g., by a micro-electromechanical system (MEMS) which is built onto a semiconductor chip. Acceleration direction, as well as orientation, vibration and shock can be sensed. The control circuitry 412 further communicates with a ringer/vibrator 416, a UI keypad/screen 418, a speaker 420, and a microphone 422.

The control circuitry 412 controls transmission and reception of wireless signals. During a transmission mode, the control circuitry 412 provides a voice signal from microphone 422, or other data signal, to the transmit/receive circuitry 406. The transmit/receive circuitry 406 transmits the signal to a remote station (e.g., a fixed station, operator, other cellular phones, etc.) for communication through the antenna 402. The ringer/vibrator 416 is used to signal an incoming call, text message, calendar reminder, alarm clock reminder, or other notification to the user. The ringer/vibrator 416 can emit one or more ring tones which are selected by the user and/or tactile vibrations. During a receiving mode, the transmit/receive circuitry 406 receives a voice or other data signal from a remote station through the antenna 402. A received voice signal is provided to the speaker 420 while other received data signals are also processed appropriately.

The mobile device 400 is a context/location-aware cell device that determines its location by sensing EM signals which are present at the different locations, and adapts its behavior to the current context or location. To achieve this, data which is obtained from sensing the EM signals is stored either at the mobile device and/or at a remote location, along with data which represents UI settings. The location data and UI data is analyzed to detect patterns, and those patterns are used to automatically configure one or more UI settings of the mobile device at appropriate times and places.

For example, consider that a user can typically make a number of manual adjustments to the UI settings of a mobile device. These include setting the ringer on or off, adjusting the ringer volume, setting the vibrate feature on or off, setting a particular ring tone from multiple available ring tones stored in the device, and setting a particular ring tone based on a caller identification. A user may turn the ringer off when going to a movie or church service to avoid disturbing others, for instance. Or, the user may set the ringer to a high volume when walking around a city where the ambient noise level is high to ensure that an incoming phone call is heard. Furthermore, a user may set a personal ring tone during non-work hours, such as a clip of popular music, and a more conservative business ring tone, such as a conventional bell ring, during work hours. Moreover, a user may set a particular ring tone based on a caller identification which varies during work and non-work hours.

A user may also configure power saving settings which cause the mobile device to go into a hibernate mode, where the screen is not lit, after a certain amount of time, or to automatically shutoff all power after a certain amount of time. It might be optimal for these settings too to vary at different times.

A user may set forwarding of incoming calls on or off, and a forwarding phone number. For example, if the user is in a meeting where use of a cell phone would be intrusive, and an important call is expected, the user can have the call forwarded to an assistant. As another example, a user at work or home may wish to have calls forward to a landline phone so that all calls can be received on one phone, such as to obtain better reception using the landline phone.

A user can set a number of rings which occur before an incoming call is routed to voicemail or forwarded. For example, during non-work hours, more rings may be appropriate. During work hours, too many rings on an unattended phone left at a desk, for instance, would disturb others, so fewer rings might be set.

A user can set alarm reminders that notify the user that voicemail or text messages have been received, or the time of a scheduled calendar/date book event has been reached. Again, different reminders during work and non-work hours, or daytime and night time hours, may be desired.

A user can set a visual message indicator such as a flashing light or screen color, or other lights built into the mobile device, where it is desirable for these indicators to differ based on the current context. Other mobile device features such as wallpaper and a screensaver, and call blocking, can similar be manually configured by the user to be most appropriate to the current context of the mobile device.

A user can also set privacy settings. For example, a location-based application in a mobile device can reveal a particular user's location to other users. The other users may be known to the particular user and previously given permission to access the location. Such an application allows a user to determine if any friends are nearby, and to arrange a meeting if desired. For privacy reasons, the user can configure the settings so that his or her location is temporarily unavailable to others, and subsequently enable the settings to again make the location available. Or, different sets of users may be allowed to access a particular user's location data when the mobile device is at different locations, or at different times. For instance, a user may enable the location-based application when going out on the town for a night and subsequently disable it. Or, the particular user may enable different group of users to access his or her location depending on whether the particular user is at work, school or home. The enabling and disabling of such privacy features can be location- and time-based.

The above examples involve configuring UI settings.

If the user forgets to set a particular setting appropriately at a particular time or place, this can result in inconvenience, embarrassment, missed communications or other problems. For example, the mobile device might ring at an inappropriate time, or with an inappropriate ring tone or volume. Or, an important incoming call might go to voicemail instead of being forwarded to a live person for appropriate handling. Or, the user's privacy may be compromised by inadvertently revealing his or her location.

To address the need for automatically configuring UI settings of a mobile device, a mobile device can be configured to change its functionality based on location and time, e.g., time of day, day/date, day of week, month, season, etc. For example, a mobile device could learn that a user attends a meeting every work day between 10am and noon, and that the user turns off the ringer and sets call forwarding to a certain phone number before each meeting. As a result of this learning, the mobile device could automatically configure itself to relieve the user of this burden the next time the meeting is attended. Moreover, the mobile device can be trained to review the user's calendar schedule and perform functions in advance that are normally done by the user. For example, the user may play golf with a group of friends every Saturday morning. The mobile device could learn this fact and perform an action such as communicating a message, such as a text message or voicemail, or message via a social networking web site such as Twitter, to remind the friends to meet at the golf course.

In another example, a user may wish to inform friends that he or she has arrived at a coffee shop. The mobile device learns that the user repeatedly sends messages via Twitter indicating his or her arrival at the coffee shop. The mobile device could then automatically send the same message with or without user ratification. As an example of ratification, the screen of the mobile device might state: “I see you're at the coffee shop again and you sent this Twitter message. Do you want to send it again?” The mode of transport could be any social networking site, a traditional email, or an SMS message, for instance. Short Message Service (SMS) is a communication service standardized in the GSM mobile communication system. The mobile device can be configured with a UI which indicates how a ratification question or other question or message is presented to the user.

In another possible approach, the mobile device could determine if it is in the location in which a calendar event is planned. If the mobile device was not in the location, it could automatically generate an email or text message to other participants in the meeting, or to the user's assistant, to indicate that the user is at another location and therefore will be late to the event or will not attend. For example, if the user is out of town at a first location, and a work meeting is scheduled to occur at a second location, the mobile device can determine that the user will not attend the second meeting and automatically generate a corresponding message. Similarly, if there are two conflicting meetings at the same time at different locations, the mobile device can determine which meeting location the user is proximate to and automatically generate a corresponding message to indicate that the user will not attend the other meeting.

The location of a user could also be tracked to determine an estimated time of arrival at a location of a meeting or other event, so that the mobile device automatically sends a message to other participants of the meeting indicating that the user will arrive in, say, ten minutes. For example, if the user is driving a car, a traffic mapping application can determine an estimate of the driving time between two locations (the current location and the event location) based on current traffic, weather and other conditions, and report this information in an automatically generated message.

Moreover, different function profiles could be built into the mobile device so that, at the touch of a button, a different person could pick up the same device and reprogram personal profile settings to immediately fit their own daily schedule and habits. Personal profiles could also be chosen by location instead of by calendar. A different set of habits could be associated with work versus home. Moreover, the mobile device could detect a corporate network and automatically configure itself in a work mode, or detect a home network and automatically configure itself in a different mode. The change in setting/modes could be indicated by change of color of an LED on the mobile device to let the owner know the current mode of the device, or by displaying an icon, text or other on-screen message, for instance.

Generally, the mobile device can automatically change its UI settings based on sensed location-identifying information. An absolute location, e.g., latitude, longitude coordinates, can be ascertained. Or, a location whose geographical position is not necessarily known can be sensed. In either case, location-identifying information can be cross referenced to one or more UI settings. For example, a mobile device can sense signals from a wireless network to learn that it is proximate to a transmitter of the network, even if the specific location of the transmitter is not known. This provides a useful indication of a location since it is highly probably that the wireless network is static and will be at the same location for a long period of time. Moreover, in some cases, an identifier of a wireless network, such as an SSID of a Wi-Fi signal can be used to access a database which yields the corresponding location. For example, Skyhook Wireless, Boston, Mass., provides a Wi-Fi Positioning System (WPS) in which a database of Wi-Fi networks is cross-referenced to latitude, longitude coordinates and place names for use in location-aware applications for cell phones and other mobile devices.

A general approach herein can focus on the use of components that are already available in a mobile device as though they were sensors. For example, Wi-Fi or Bluetooth receivers can be used to sense the presence of signals without necessarily establishing a network connection. Another example is to use a camera in the mobile device to detect light levels, although that is not the primary purpose of a camera. Another example is to use a microphone to detect ambient audio levels. We can essentially use the technical facilities of the mobile device in way which were perhaps not originally intended by the designer of the mobile device, to create an enhanced situational awareness that can drive actions or mode changes.

FIG. 5 depicts a mobile device network. As mentioned, data which is obtained by a mobile device from sensing EM signals at different locations can be stored either at the mobile device and/or at a remote location, along with data which represents UI settings. For example, the mobile device 100 may communicate via a mobile device server 504 and a backend server such as a database server 502 via a network 500 to upload data from sensing EM signals. The mobile device server 504 is responsible for handling communications to and from the mobile device, while the database server 502 can store location data, time data and UI data, cross referenced to one another, in one possible approach. This data can alternatively or additionally be stored at the mobile device 100. The database server 502 can store a database of Wi-Fi networks cross-referenced to latitude, longitude coordinates, and place names, mentioned previously, for access by the mobile device 100. The database server 502 could also store information for resolving data from EM signals to obtain a location of a surveyed device.

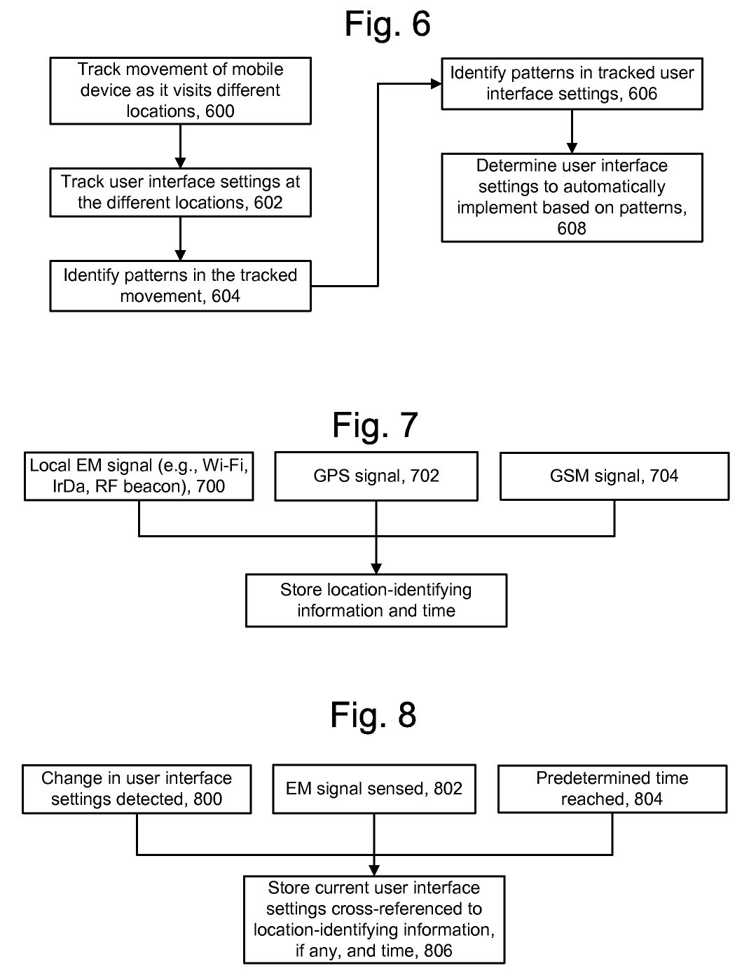

FIG. 6 depicts a process for tracking a mobile device. As mentioned, the location and UI settings of a mobile device can be tracked over a period of time such as several days, and patterns can be detected based on this tracking. Based on the patterns, one or more UI settings can be automatically configured at appropriate times and places. In this and other flowcharts herein, the steps performed are not necessarily performed separately and/or in the order shown.

In a high level overview of a tracking process, step 600 includes tracking movement of a mobile device as it visits different locations. For instance, this can include obtaining location-identifying information from EM signals at the different locations. The location-identifying information can include, e.g., information for ascertaining an absolute geographical position of the mobile device, and/or an identifier of a wireless network at the location. It is also possible to use more than one mode of location determination to increase accuracy or to corroborate results. Or, a most accurate available mode of location determination can be used. For example, a Wi-Fi network typically provides the most accurate results when the mobile device is indoors where GPS signals are often blocked or severely attenuated. GSM may be less accurate than GPS, depending on the cell size, but is usually available indoors. Outdoors, in urban areas, GPS and Wi-Fi location accuracy are comparable. In suburban or rural areas, Wi-Fi is typically not available. An appropriate table, list or other data structure can be used to store the location data cross-referenced to time, for instance. For example, the data structure may include multiple records or entries, each providing: (latitude, longitude, time), or (network identifier, e.g., SSID, time). Note that different (latitude, longitude) results can be considered to be the same location when they are within a specified distance of one another which reflects an accuracy of the location determination.

Step 602 includes tracking user interface (UI) settings at the different locations. This can include any of the many UI settings mentioned previously, which are typically manually configured by the user. Note that the settings can be manually configured one or more times in connection with a particular location. Settings can be configured while the mobile device is at the location and/or shortly before or after the device visits the location. For example, a user may set a ringer off and a vibrate notification on when entering a coffee shop to avoid disturbing other patrons with the ringer when a call is received. While at the coffee shop, just before leaving, or just after leaving the coffee shop, the user may set the ringer back on and the vibrate notification off. These settings can each be tracked. A setting which is detected within a time window before a mobile device first senses a location, and a setting which is detected within a time window after a mobile device last senses a location, can be associated with the location.

Also, settings can be configured well before the device is at a location, so that the settings take effect when the device is at the location. For example, the user may use a calendar application to associate a profile which silences a ringer with certain meeting times which are entered into the calendar application. In this case, the ringer can be automatically silenced several minutes before the meeting start time.

Moreover, a change in a setting as well as the existence of a current setting which was not necessarily recently changed be tracked. An appropriate table, list or other data structure can be used to store the UI settings cross-referenced to location and/or time, for instance. For example, the data structure may include multiple records or entries, each providing: (UI setting 1, UI setting 2, UI setting 3, . . . ) cross referenced to (network identifier, e.g., SSID), (time) and/or (latitude, longitude). UI setting 1, UI setting 2, UI setting 3, represent different UI settings, such as UI setting 1=ringer on, UI setting 2=personal ring tone, and UI setting 3=call forwarding off. In some cases, a UI setting is not associated with a location but is only cross-referenced to time, e.g., time of day, day of week, etc.

Step 604 includes identifying patterns in the tracked movement of the mobile device. For example, this can include locations that are visited repeatedly, e.g., a certain threshold number of times, or with a threshold frequency. For instance, a user may visit a coffee shop which is identified by its Wi-Fi network 3-5 mornings a week on the way to work. A pattern can also be detected from locations which are visited in a sequence multiple times. For example, the sequence of: home to work and work to home may occur five days per week, and the sequence of home to coffee shop to work may occur 3-5 times per week. The sequence of home to golf course may occur once per week. As another example, a user at his or her work place may be tracked at a desk location, a conference room and a lunchroom. A pattern may include: desk to conference room to desk to lunchroom to desk.

Step 606 includes identifying patterns in the tracked UI settings. For example, it may be determined that the user turns off the ringer of the mobile device when going to the coffee shop in the morning, and turns it back on when going to work afterwards. Further, the user sets one ring tone during work hours and another ring tone during non-work hours. Further, the user silences the ringer and sets up call forwarding during a certain time at work.

Patterns can be determined using any type of pattern detection algorithm. For example, locations which are visited repeatedly can be determined by counting the number of times an identifier of the location appears in the stored data. Sequences of locations which are visited repeatedly can be determined by counting the number of times identifiers of the locations in a sequence appears in the stored data, in a specified order. Moreover, probabilistic metrics can be assigned to patterns. For example, in the example of: home to coffee shop to work 3-5 times per week, or ⅘ time per week on average, a probability of ⅘=0.80 may be assigned. Thus, for a given workday, Monday through Friday, there is an 80% probability that the user will go from home to coffee shop to work. A pattern may be detected in that the user is more likely to go to the coffee shop on a certain day of the week such as Friday, e.g., with a 90% probability.

Further, the probability that the user configures a certain UI setting can be assigned a probability. For instance, the user may turn off the ringer when visiting the coffee shop 9 times out of 10, resulting in a 90% probability. In another example, the user may turn off the ringer when visiting the coffee shop 9 times out of 10, within 10 minutes before the location of the coffee shop is first sensed, or within 10 minutes after the location of the coffee shop is first sensed, again resulting in a 90% probability. In another example, the user may turn off the ringer when visiting the coffee shop 7 times out of 10, within 5 minutes before the location of the coffee shop is first sensed, or within 5 minutes after the location of the coffee shop is first sensed, resulting in a 70% probability. Over time, new patterns can be detected, old patterns can be phased out due to non-use, and existing patterns can be refined. Based on a sufficiently high probability of a particular UI setting being made by the user at a particular time and/or place, the mobile device can automatically implement the setting. For example, a threshold probability may be defined which must be exceed to implement a setting.

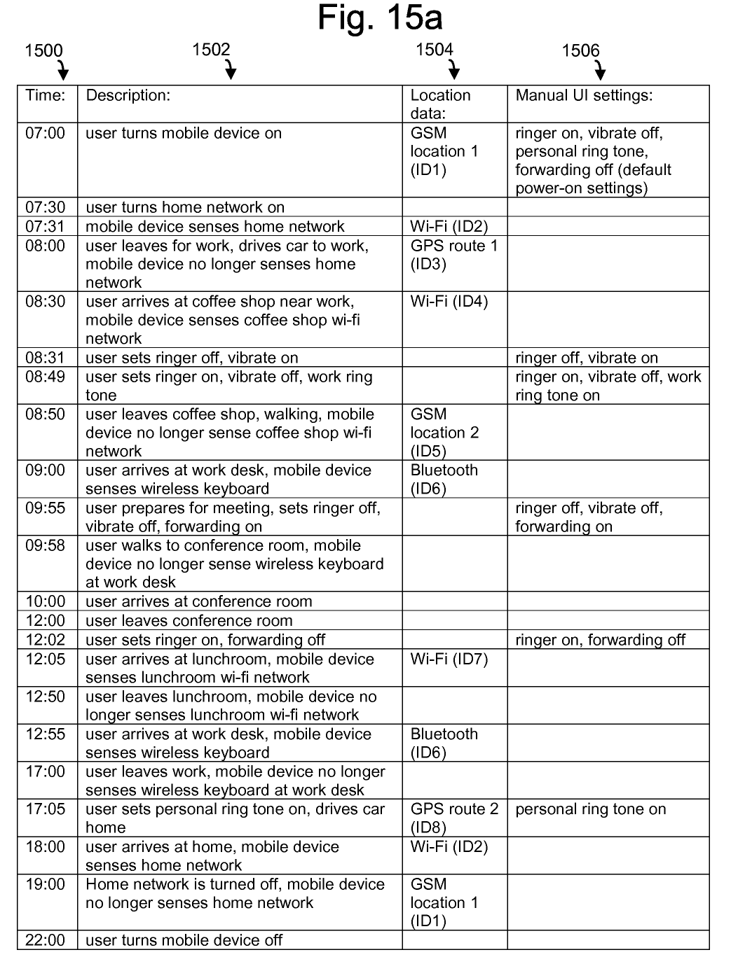

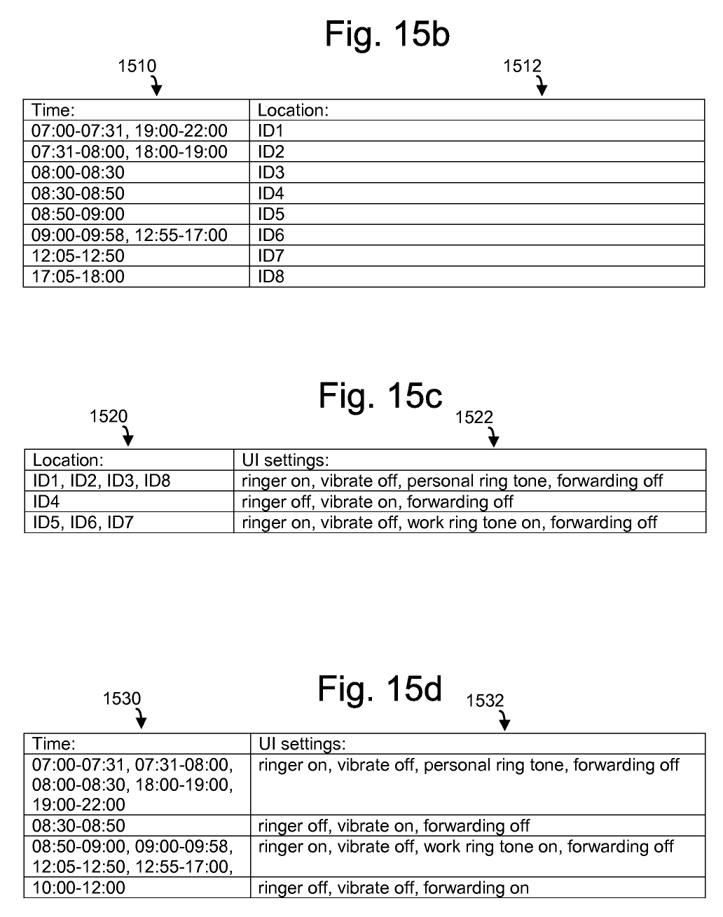

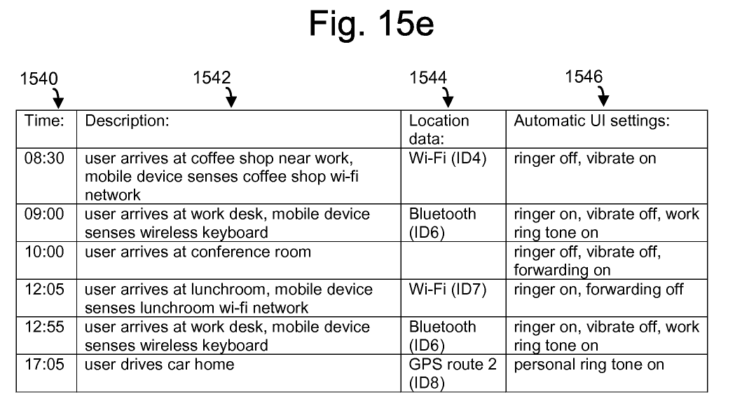

A further detailed example regarding location and UI setting patterns is provided in connection with FIGS. 15a-e.

Step 608 includes determining a UI setting to automatically implement based on the patterns. For example, in the case where the user turns the ringer off when visiting the coffee shop, the mobile device can automatically sense when it is at the coffee shop, such as based on an SSID of the Wi-Fi network, and set the ringer off, without requiring any manual intervention by the user. The mobile device can optionally inform the user that an automatic setting has been implemented (see, e.g., FIG. 14c and related discussion). Similarly, the mobile device can automatically sense when it is no longer at the coffee shop, and automatically set the ringer back on or revert to some other UI setting or profile.

FIG. 7 depicts tracking of location-identifying information by a mobile device, and provides further details regarding step 600 of FIG. 6. Location data can be obtained from one or more sources, as mentioned. These include local EM signals 700, such as from a Wi-Fi (wireless LAN), IRDA (infrared) and RF beacon. These are signals that are emitted from within a particular location which a mobile device visits, such as an office building, warehouse, retail establishment, or the like. GPS signals 702 are emitted from satellites which orbit the earth and are therefore not emitted from a particular location which a mobile device visits. Instead, the GPS signals are used by the mobile device to determine a geographical location, such as latitude, longitude coordinates, which identifies an absolute position of the mobile device on earth. This location can be correlated to a place name using a lookup to a database. GSM signals 704 are generally emitted from antennas which are mounted to buildings or dedicated towers or other structures. In some cases, the sensing of a particular GSM signal and its identifier can be correlated to a particular location with sufficient accuracy, such as for small cells (e.g., picocells or femtocells). In other cases, such as for macro cells, identifying a location with desired accuracy can include measuring power levels and antenna patterns of cell phone antennas, and interpolating signals between adjacent antennas.

Block 706 denotes storing location-identifying information such as an absolute location (e.g., latitude, longitude) or a signal identifier which represents a location. For example, Wi-Fi signal identifier can be an SSID, in one possible implementation. An IRDA signal and RF beacon will typically also communicate some type of identifier which can be used as a proxy for location. For example, when a POS terminal at a retail store communicates an IRDA signal, the signal will include an identifier of the retail store, such as “Sears, store #100, Chicago, Ill.” An RF beacon is a surveyed device and will similarly include an identifier which is cross referenced to a location in a database by an administrator who configures the beacon and assigns the location. An example database entry is: Beacon_ID=12345, location=office conference room.

FIG. 8 depicts tracking of user interface settings by a mobile device, and provides further details regarding step 602 of FIG. 6. User interface settings can be tracked based on when a change in UI settings is detected (800). For example, the mobile device can be configured so that when a user command is received to change a UI setting (such as “ringer off”), the command is stored, in addition to being implemented. UI settings can also be tracked based on when an EM signal is sensed (802). For example, when a mobile device first senses a Wi-Fi network, the current UI settings (e.g., UI setting 1=ringer on, UI setting 2=personal ring tone, and UI setting 3=call forwarding off) can be stored. The mobile device may repeatedly sense the same network, or otherwise determine that it is at the same location, every few minutes, for instance, in which case it is not necessary store the same UI setting each time the same network is sensed or the same location determination is made. One possible approach is to store the same UI setting when the mobile device arrives at and departs from, a given location. For a Wi-Fi network, this is indicated when the Wi-Fi signal is sensed the first and last times. For a GPS or GSM network, this may be indicated when the GPS or GSM signals indicate that the mobile device arrives at and departs from, a zone which is centered about a specified latitude, longitude location or cell.

UI settings can also be tracked based on when a predetermined time is reached (804). For instance, UI settings can be recorded periodically, e.g., every few minutes, and/or at certain times, e.g., 8am, noon and 6pm each day, or at different times for different days of the week.

Block 806 includes storing the current UI settings cross-referenced to an EM identifier, if any, and to time.

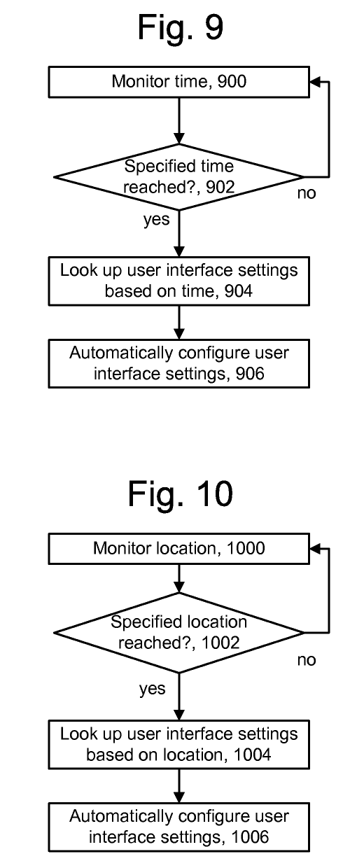

FIG. 9 depicts a process for automatically configuring UI settings of a mobile device based on time. After one or more location and/or UI setting patterns have been detected, user settings can be automatically configured based on time. At step 900, time is monitored, e.g., using a clock function of a controller of the mobile device. If a specific time is reached at decision step 902, one or more UI settings are looked up based on the time, at step 904. The lookup can also be based on location. The data which is looked up can be stored at the mobile device or at a remote location, in which case the mobile device makes a call to the remote location to obtain the UI settings. Step 906 includes automatically configuring the UI settings.

FIG. 10 depicts a process for automatically configuring UI settings of a mobile device based on location. After one or more location and/or UI setting patterns have been detected, user settings can be automatically configured based on location. At step 1000, location is monitored, e.g., using a network identifier or GPS or GSM signal which is sensed by the mobile device. If a specific location is reached at decision step 1002, one or more UI settings are looked up based on the location, at step 1004. The lookup can also be based on time. The data which is looked up can be stored at the mobile device or at a remote location, in which case the mobile device makes a call to the remote location to obtain the UI settings. Step 1006 includes automatically configuring the UI settings.

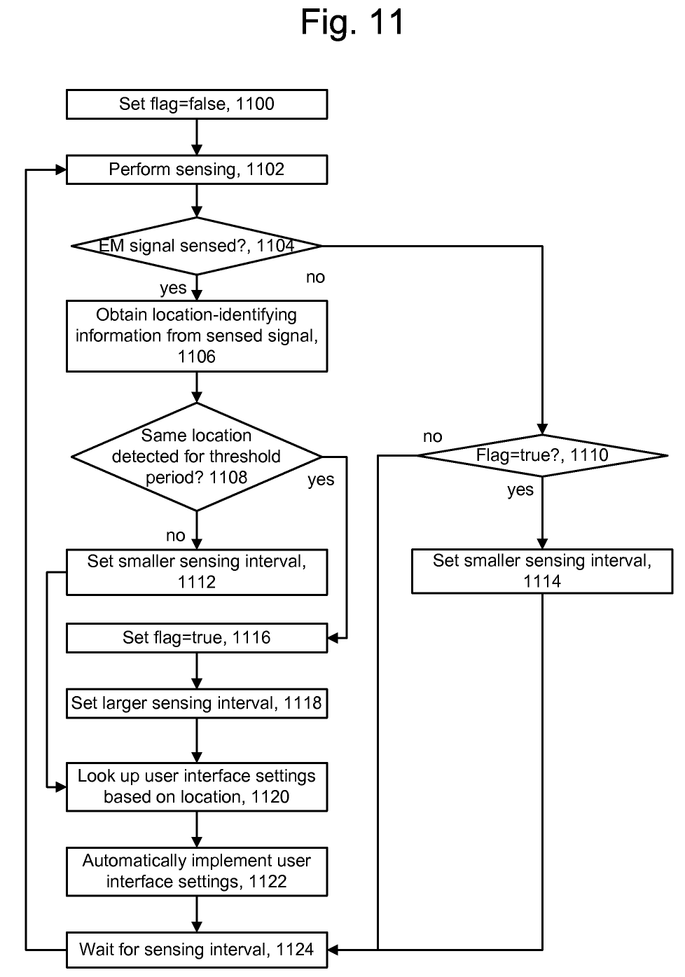

FIG. 11 depicts a process for sensing electromagnetic radiation at different time intervals. As mentioned, a mobile device obtains data relating to its current location by sensing EM signals. To limit power consumption, the sensing operation can be performed at specified times. Moreover, the sensing can occur less often when it is determined that the mobile device has remained at the same location for some time. Once the mobile device leaves the location, the sensing operation can occur more frequently. Further, the automatic implementation of a UI setting can be delayed until it has been determined that the mobile device has remained at the same location for some time. This avoids a potentially confusing situation in which the UI settings are changed rapidly or unnecessarily often when the mobile device senses different locations, such as due to the physical movement of the mobile device across the different locations and/or the presence of competing overlapping EM signals, such as from multiple nearby Wi-Fi networks.

In an example process, a flag is set to false at step 1100. The flag is true when the mobile device has been at the same location for a threshold period of time, e.g., several minutes. Sensing is performed at step 1102, such as by activating an RF or infrared receiver (see 406 and 408 in FIG. 4). The sensing can involve passive scanning of one channel, or a range of channels, to determine whether one or more signals are present. If a signal is present, the signal can be decoded to obtain identifying information such as an SSID. For GPS and GSM applications, the signal may include identifying information of the satellite or antenna and its location, in addition to timing information. If an EM signal is sensed at decision step 1104, an identifier is obtained and/or a location is determined from the sensed signal. At decision step 1106, location-identifying information is obtained from the sensed signal. At decision step 1108, if the same location has been detected for a threshold period of time, the flag is set to true at step 1116. A larger sensing interval (the time between successive sensing operations) is set at step 1118 so that sensing will occur less frequently. At step 1120, user interface (UI) settings based on location are looked up, and at step 1122, the UI settings are automatically implemented. A wait for the sensing interval is implemented at step 1124, after which sensing is again performed at step 1102.

At decision step 1104, if no EM signal is sensed, and the flag is true, at decision step 1110, a smaller sensing interval is set at step 1114, so that sensing will occur more frequently. This corresponds to the case where the mobile device leaves a location and begins sensing more frequently to detect a next location. If the flag is false, at decision step 1110, the sensing interval is not changed, and a wait for the sensing interval is implemented at step 1124. At decision step 1108, if the location has not yet been detected for a threshold period of time, the flag is still false, and steps 1120, 1122 and 1124 are implemented as discussed.

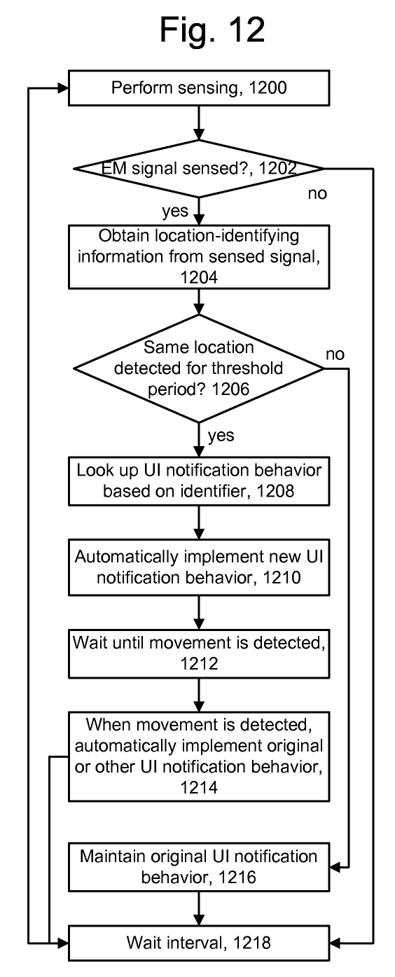

FIG. 12 depicts a process for automatically configuring UI settings of a mobile device based on motion sensing. As mentioned in connection with FIG. 4, a mobile device may have a movement/motion sensor 414 such as an accelerometer. Information from an accelerometer, together with location-identifying information, can be used to automatically configure UI settings. In an example implementation, sensing is performed at step 1200. If an EM signal is sensed, at decision step 1202, location-identifying information is obtained from the signal at step 1204. For example, the mobile device may sense that it is in the user's home. If the same location has been detected for a threshold period of time at decision step 1206, a user interface (UI) notification behavior is looked up based on the location-identifying information at step 1208, and the behavior is automatically implemented at step 1210. The notification may relate to an audible and/or visual alert which the mobile device provides in response to, e.g., incoming phone calls, text messages, calendar notifications, and alarms. Audible alerts include ringer or ring tone type and volume. Visual alerts include flashing message lights, screen colors, or other lights built into the device.

For example, the user may place the mobile device on a table so that it is stationary for the threshold period, e.g., several minutes or hours, such as when the user is sleeping. An appropriate UI behavior to automatically implement at the location might include setting the ringer off or to a lower volume. Other information such as time of day can be considered in selecting an appropriate UI behavior. Before the UI behavior is automatically implemented, an original UI notification behavior is set, manually or automatically. For instance, the mobile device might have the ringer on at a high volume.

Step 1212 involves waiting until movement is detected. For example, when the user awakes, he or she picks up the mobile device from the table, at which point motion is sensed. At step 1214, when movement of the mobile device is detected, a different UI behavior is automatically implemented. For example, the mobile device may revert to the previous, original UI settings, e.g., ringer on at high volume. A wait interval is then implemented at step 1218 before sensing again at step 1200. If an EM signal is not sensed at decision step 1202, the original UI notification behavior is maintained at step 1216 and the wait interval is implemented at step 1218.

Note that the process of FIG. 12 can apply to any UI behavior and not just notification settings.

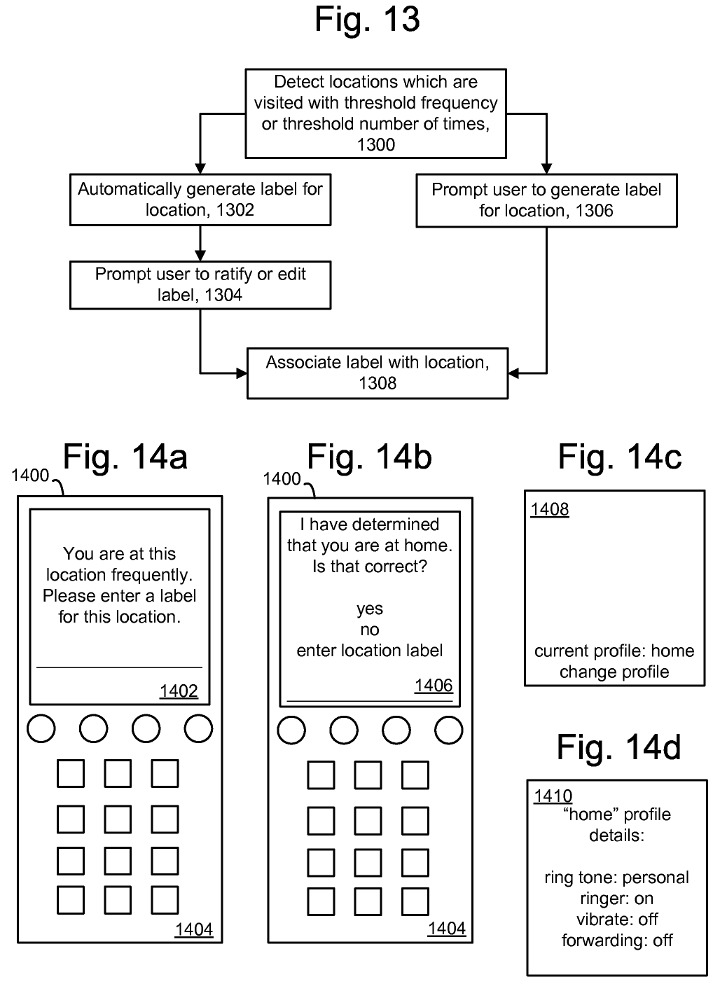

FIG. 13 depicts a process for automatically generating a label for a location, or prompting a user to input a label. A label is a user-friendly name of a location, such as “home,” “work,” “conference room,” or “coffee shop.” It is helpful to inform the user which location is currently sensed by a readily-understandable label which serves as a confirmation to the user that the location has been recognized and that the appropriate UI settings are being automatically implemented based on the location. In some cases, the user may decide to override the automatic UI settings. Or, the label may be incorrect, in which case the user can manually correct it. In one approach, the mobile device automatically assigns or proposes to assign a label to a particular location. For example, a mobile device may sense that it is at a particular location between 11pm and 7am each day, with a high probability. The device can apply heuristics to conclude that the location is the user's home. Similarly, a location which is visited during traditional work hours of 9am-5pm may be assigned the label “work.” In another approach, the mobile device automatically prompts the user to provide a label for a particular location when the location is visited frequently, a threshold number of time and/or for a threshold period of time, including a minimum cumulative time over multiple visits to the location, and a minimum time per visit.

Moreover, the sensed EM signal may provide location information which can be used as a label. In the previously-mentioned example of a mobile device interacting with a point of sale terminal, the information “Sears, store #100, Chicago, Ill.” was provided to the mobile device in an IRDA infrared signal. This information can be used as a label. In other cases, information from an SSID of a Wi-Fi network may include information (e.g., an ASCII character string such as “Starbucks at 2^{nd} Ave”) which can be used as a label, or information (e.g., sets of bits) which can be used to lookup a label by using a service such as the previously-mentioned Skyhook Wireless Wi-Fi Positioning System. In the latter case, the mobile device can transmit a query to a remote database server with the SSID and receive a place name in return which can be used as a label.

Step 1300 includes determining locations which are visited with a threshold frequency and/or a threshold number of times. For example, a particular coffee shop may be visited 3-5 times per week, and the visits may not trigger an automatic labeling process or a prompt to the user to provide a label until the coffee shop is visited a threshold number of times, such as a total of ten times. Step 1320 includes automatically generating a label for the location. Step 1304 includes optionally prompting the user to ratify or edit the label (see FIG. 14b). Alternatively, step 1306 includes prompting the user to generate a label for the location (see FIG. 14a). Step 1308 includes associating the label with the location, such as by storing the label name cross-referenced to the location-identifying information.

FIG. 14a depicts a UI of a mobile device which prompts a user to enter a label for a location. The mobile device 1400 includes a display screen 1402 for viewing information and a key pad 1404 for entering information. Some touch screen mobile device uses a virtual keypad which is displayed on a screen. The screen 1402 displays a message to the user informing him or her that the user has visited the current location frequently, and that the user should enter a label for the location. The user can enter an appropriate label via the keypad 1404. It is also possible for the user to review prompts for location labels at different times when he or she is not at the location. For example, at the end of the day or week, the user may view a menu of locations visited and determine which need to have a label assigned. Edits to existing labels can also be made.

FIG. 14b depicts a UI of a mobile device which automatically determines a label for a location, and prompts a user to ratify the label. Here, the mobile device, in the screen 1406, proposes to automatically assign a label of “home” to the current location, and asks the user to ratify the proposed label. The user can select “yes” if the proposed label is acceptable, or “no” if it is not, in which case the user is requested to enter a desired location name.

FIG. 14c depicts a UI of a mobile device which informs a user of a current UI profile. As mentioned, it can be helpful to inform the user which location is currently sensed to serve as a confirmation to the user that appropriate UI settings are being automatically implemented based on the location, to allow the user to override the automatic UI settings, or to manually correct the label. Here, the screen 1408 indicates that the current profile is “home,” which means certain UI settings, e.g., a profile, which are associated with the location are automatically implemented. The screen also allows the user to change the profile. The current profile can be indicated by text and/or graphics/images. Further, the user may be able to select a particular graphic or image for each location.

FIG. 14d depicts a UI of a mobile device which informs a user of details of a current UI profile. The screen 1410 provides details of the “home” profile, including ring tone: personal, ringer on, vibrate off and forwarding off. The user may decide that one or more of the UI settings should be changed and can make such a change using appropriate UI menus.

FIG. 15a depicts an example sequence of events of a user in a day, with corresponding location data and manually-configured UI settings. As mentioned, the locations visited by a mobile device and the UI settings of the mobile device can be tracked over time, such as a number of days, and patterns can be detected for automatic implementation of UI settings. Moreover, the tracking can be ongoing so that previous determinations regarding automatic implementation of UI settings are confirmed or modified. The example record provided lists tracked events which occur in one day. A similar record may be obtained for additional days as well. Furthermore, the records can vary as different locations are visited and different UI settings are made by the user.

In the record or table, a column 1500 denotes time (24-hour notation is used). A column 1502 provides a description of an event. A column 1504 indicates location data which is sensed by a mobile device and tracked, e.g., stored and analyzed, to detect patterns. A column 1506 indicates manual UI settings which are made by a user, and which are tracked to detect patterns. At 07:00, a user wakes up and turns the mobile device on. The mobile device senses its location from GSM signals, and assigns an identifier ID1 to the determined location. At this time, the UI settings in effect may be manually configured by the user, or they may be default settings which are made when the mobile device is powered on. At 07:30, the user turns on a home network. One minute later, at 07:31, the mobile device senses the home network and assigns an identifier ID2 to the location, which is a Wi-Fi location. At 08:00, the user leaves for work, driving a car, so that the mobile device no longer senses the home network. Instead, GPS signals are sensed, and a location or set of locations on the route to work are assigned an identifier ID3.

At 08:30, the user arrives at a coffee shop near the work place, and the mobile device senses a Wi-Fi network having an identifier ID4 at the coffee shop. At 08:31, the user manually changes the UI settings by turning the ringer off and the vibrate feature on, so that other patrons of the coffee shop will not be disturbed by any incoming phone call. Column 1506 indicates that these settings are recorded. At 08:49, the user gets ready to leave the coffee shop and changes the UI settings back to the previous state (ringer on, vibrate off), and additionally sets a ring tone which is suitable for work. At 08:50, the user leaves the coffee shop, walking to work, and the mobile device no longer senses the coffee shop Wi-Fi network. However, GSM signals are detected and assigned an identifier ID5. At 09:00, the user arrives at the work desk and the mobile device senses a wireless keyboard, for instance, via Bluetooth signals, assigning an identifier ID6.

The user works until 09:55 at which time he or she prepares for a meeting. To avoid any distractions from the mobile device during the meeting, the user sets the ringer and vibrate feature off (this may be accomplished by a single “silent mode” commandibutton), and sets a forwarding feature on so that incoming calls are forwarded to an assistant. At 09:58, the user walks to the conference room and attends the conference from 10:00 to 12:00. As an example, presume that no location data is available at this time as GPS signals are blocked indoors and GSM signals are also blocked or are not available. Or, such signals are available but are not used for determining location. At 12:02, the user has left the conference room and returns the mobile device to its prior work place setting (ringer on, forwarding off). The user arrives at a Wi-Fi equipped lunchroom at 12:05 and the mobile device senses the Wi-Fi signals, obtaining an identifier of ID7. At 12:50, the user leaves the lunchroom, at which time the Wi-Fi network is no longer sensed, and returns to the work desk at 12:55, where the Bluetooth signals from the wireless keyboard are sensed again. The mobile device recognizes that it is again at the same location which has the identifier ID6.

At 17:00, the user leaves the work desk so that the Bluetooth signals from the wireless keyboard are no longer sensed. At 17:05, the user sets a personal ring tone and begins to drive home. GPS signals are sensed at one or more locations along the route, and assigned an identifier of ID8. It is also possible for the mobile device to determine that it is following the same route of ID3 in reverse. At 18:00, the user arrives at home and the mobile device senses the home Wi-Fi network with ID2. The mobile device recognizes that it is again at the same location which has the identifier ID2. At 19:00, the home network is turned off so that it is no longer sensed. The mobile device reverts to sensing GSM signals. The mobile device recognizes that it is again at the same location which has the identifier ID1. At 22:00, the user turns the phone off.

In the above scenario, the user changes the UI settings a number of times (column 1506) and these changes can be recorded for analysis, such as to detect patterns in locations, UI settings and time.

FIG. 15b depicts a listing of location identifiers versus time from the example sequence of events of FIG. 15a. Column 1510 denotes time entries and column 1512 denotes corresponding location identifiers. In some cases, multiple ranges of time are associated with the same identifier. For example, ID1 is associated with 07:00-07:31 and 19:00-22:00, ID2 is associated with 07:31-08:00 and 18:00-19:00, and ID6 is associated with 09:00-09:58 and 12:55-17:00. The other time periods are associated with the other identifiers as indicated. The listing indicates patterns of locations cross referenced to time. As mentioned, such data can be obtained over several days, for instance, to identify patterns with greater certainty. Moreover, different location identifiers can be associated with the same location. For instance, ID1 and ID2 both represent the user's home.

FIG. 15c depicts a listing of manually-configured UI settings versus location identifiers from the example sequence of events of FIG. 15a. Column 1520 denotes time entries and column 1522 denotes corresponding UI settings. Here, a number of different location identifiers are associated with common UI settings. For example, ID1, ID2, ID3 and ID8 are associated with a UI profile of: ringer on, vibrate off, personal ring tone and forwarding off. ID4 is associated with a UI profile of: ringer off, vibrate on, and forwarding off. ID5, ID6, and ID7 are associated with a UI profile of: ringer on, vibrate off, work ring tone and forwarding off.

FIG. 15d depicts a listing of manually-configured UI settings versus time from the example sequence of events of FIG. 15a. Column 1530 denotes time entries and column 1532 denotes corresponding UI settings. A number of different time periods are associated with common UI settings. For example, 07:00-08:30, comprising multiple adjacent periods, is associated with a UI profile of: ringer on, vibrate off, personal ring tone and forwarding off. 08:30-08:50 is associated with a UI profile of: ringer off, vibrate on, and forwarding off. 08:50-09:58, 12:05-12:50 and 12:55-17:00 are associated with a UI profile of: ringer on, vibrate off, work ring tone and forwarding off. 10:00-12:00 is associated with a UI profile of: ringer off, vibrate off and forwarding on. Note that this last time period (when the user is in the conference room) provides information which is not cross referenced to location data since location data was not obtained in this time period.

FIG. 15e depicts an example sequence of events of a user in a day, with corresponding location data and automatically-configured UI settings, based on the sequence of FIG. 15a. Using the patterns which are detected, such as depicted in FIGS. 15-15d, UI settings can be automatically configured in some situations. Column 1540 denotes time, column 1542 provides an event description, column 1544 denotes location data, and column 1546 denotes automatic UI settings which are implemented. A subset of the events of FIG. 15a is depicted in which automatic UI settings are implemented. At 08:30, ringer off and vibrate on are set based on detection of the coffee shop Wi-Fi (ID4). At 09:00, ringer on, vibrate off, and work ring tone on are set based on detection of the Bluetooth signal from the wireless keyboard (ID6). At 10:00, ringer off, vibrate off and forwarding on are set based on detection of the start time of the 10:00-12:00 meeting. At 12:05, ringer on and forwarding off are set based on detection of the lunchroom Wi-Fi network (ID7). At 12:55, ringer on, vibrate off and work ring tone on are set based on detection of the Bluetooth signal from the wireless keyboard (ID6). At 17:05, personal ring tone on is set based on detection of the GPS route from work to home (ID8).

As mentioned, both time and location patterns can be used to provide automatic UI settings. For example, regarding the setting of ringer off and vibrate on based on detection of the coffee shop Wi-Fi (ID4), this event occurs on average at about 08:30 each weekday, 3-5 times per week. Optionally, a time constraint may be imposed so that the automatic setting is implemented if the Wi-Fi detection is within a specified time window, such as within 30 minutes before or after 08:30. A constraint as to the day of week can also be imposed so that the automatic UI setting is implemented only on weekdays, or other days of the week, for instance. Specials days such as holidays can also be accounted for so that the automatic UI setting is not implemented on a holiday, for instance.

Moreover, the automatic implementation of a UI setting can be triggered by either entering a location, such as evidenced by detection of an EM signal associated with the location, or leaving a location, such as evidenced by detecting an EM signal associated with the location followed by no longer detecting an EM signal associated with the location. For instance, regarding the setting of the ringer on, vibrate off and work ring tone on, based on detection of the Bluetooth signal from the wireless keyboard (ID6), this could alternatively be triggered by detecting that the mobile phone has left the lunchroom Wi-Fi network (ID7). Another approach uses a sequence which includes departure from one location and arrival at another location to trigger automatic UI settings. A time window between the departure and arrival can be imposed so that a time difference between the departure and arrival which is within the time window triggers an automatic UI setting while a time difference between the departure and arrival which is not within the time window does not trigger an automatic UI setting. Yet another possible approach uses a sequence which includes arrival at a first location followed by arrival at a second location to trigger an automatic UI setting, while arrival at the second location which is not preceded by arrival at the first location does not trigger an automatic UI setting, or triggers a different UI setting. Many variations are possible.

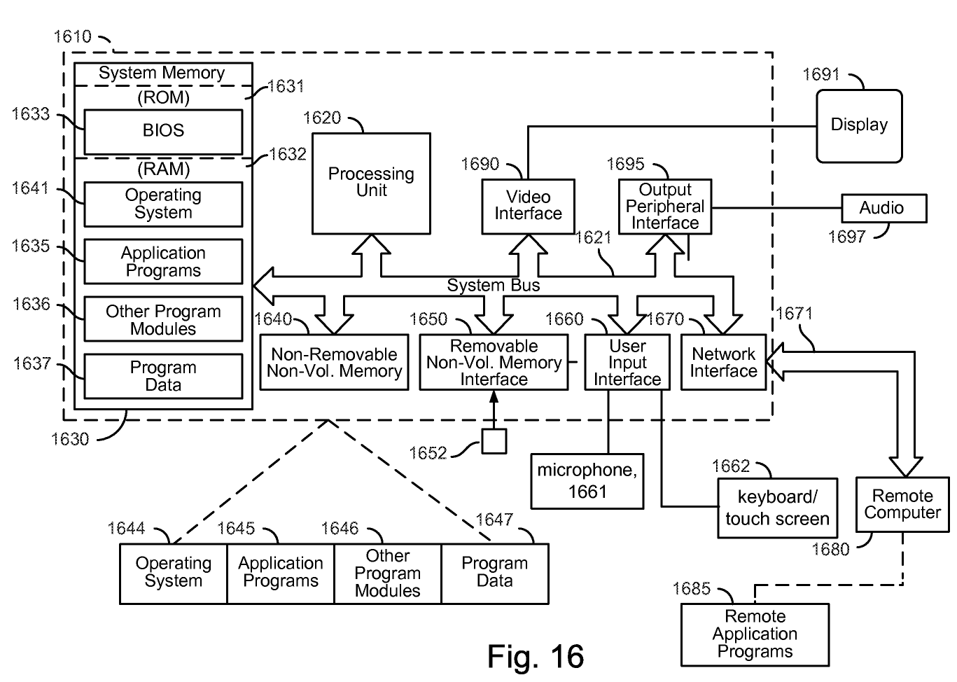

FIG. 16 depicts an example block diagram of computer hardware suitable for implementing various embodiments. The computer hardware can represent the mobile device of FIG. 4, for instance. An exemplary system for implementing various embodiments includes a general purpose computing device 1610. Components of computing device 1610 may include a processing unit 1620, a system memory 1630, and a system bus 1621 that couples various system components including the system memory to the processing unit 1620. The system bus 1621 may be, e.g., a memory bus or memory controller, a peripheral bus, and a local bus using any of a variety of bus architectures.

Computing device 1610 can include a variety of computer- or processor-readable media. Computer readable media can be any available media that can be accessed by computing device 1610 and includes both volatile and nonvolatile media, removable and non-removable media. Computer readable media may comprise computer storage media such as volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 1610. Combinations of any of the above are also included within the scope of computer readable media.

The system memory 1630 includes computer storage media in the form of volatile and/or nonvolatile memory such as read only memory (ROM) 1631 and random access memory (RAM) 1632. A basic input/output system 1633 (BIOS), containing the basic routines that help to transfer information between elements within computing device 1610, such as during start-up, is typically stored in ROM 1631. RAM 1632 typically contains data and/or program modules that are immediately accessible to and/or presently being operated on by processing unit 1620. For example, an operating system 1634, application programs 1635, other program modules 1636, and program data 1637 may be provided.

The computing device 1610 may also include other removable/non-removable, volatile/nonvolatile computer storage media. By way of example only, FIG. 16 illustrates a non-removable, nonvolatile memory 1640 such as solid state memory, and a memory card (e.g., SD card) interface/reader 1650 that reads from or writes to a removable, nonvolatile memory card 1652. Other removable/non-removable, volatile/nonvolatile computer storage media that can be used in the exemplary operating environment include, but are not limited to, flash memory cards, digital versatile disks, digital video tape, solid state RAM, solid state ROM, and the like.

The computer storage media provide storage of computer readable instructions, data structures, program modules and other data for the computing device 1610. For example, non-removable, nonvolatile memory 1640 is illustrated as storing operating system 1644, application programs 1645, other program modules 1646, and program data 1647. These components can either be the same as or different from operating system 1634, application programs 1635, other program modules 1636, and program data 1637 in the system memory 1630. Operating system 1644, application programs 1645, other program modules 1646, and program data 1647 are given different numbers here to illustrate that, at a minimum, they are different copies. A user may enter commands and information into the computing device 1610 through input devices such as a keyboard/touch screen 1662 and microphone 1661. Other input devices (not shown) may include a joystick, game pad, satellite dish, scanner, or the like. These and other input devices are often connected to the processing unit 1620 through a user input interface 1660 that is coupled to the system bus, but may be connected by other interface and bus structures, such as a parallel port, game port or a universal serial bus (USB). A display/monitor 1691 is also connected to the system bus 1621 via an interface, such as a video interface 1690. Other peripheral output devices such as an audio output 1697 may be connected through an output peripheral interface 1695.

The computing device 1610 may operate in a networked environment using logical connections to one or more remote computing devices, such as a remote computing device 1680. The remote computing device 1680 may be another mobile device, a personal computer, a server, a router, a network PC, a peer device or other common network node, and typically includes many or all of the elements described above relative to the computing device 1610. Such networking environments are commonplace in offices, enterprise-wide computer networks, intranets and the Internet.

When used in a networking environment, the computing device 1610 is connected to another network through a network interface or adapter 1670. In a networked environment, program modules depicted relative to the computing device 1610, or portions thereof, may be stored in the remote memory storage device. For example, remote application programs 1685 can reside on memory device 1681. The network connections shown are exemplary and other means of establishing a communications link between the computing devices may be used.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

We claim:

1. A processor-implemented method for controlling a context-aware mobile device which communicates by wireless signals, comprising:
tracking movement of the mobile device by the mobile device sensing electromagnetic radiation which is present at different locations visited by the mobile device and storing location-identifying information associated with the electromagnetic radiation at each location;
identifying at least one pattern in the movement of the mobile device based on the tracking of the movement;
tracking user interface settings of the mobile device by storing at least one user interface setting of the mobile device, cross referenced to the location-identifying information, when the mobile device is present at the different locations;
identifying at least one pattern in the user interface settings of the mobile device relative to the different locations based on the tracking of the user interface settings; and
automatically, without user intervention, modifying the at least one user interface setting of the mobile device, based on the at least one pattern in the movement of the mobile device and the at least one pattern in the user interface settings of the mobile device.

2. The processor-implemented method of claim 1, further comprising:
storing the at least one user interface setting of the mobile device cross referenced to time, the at least one pattern in the user interface settings includes a pattern in the user interface settings relative to time.

3. The processor-implemented method of claim 1, wherein:
the tracked user interface settings are manually set by a user of the mobile device when the mobile device is at the different locations.

4. The processor-implemented method of claim 1, wherein:
the identifying at least one pattern in the movement of the mobile device includes identifying at least one location which is repeatedly visited.

5. The processor-implemented method of claim 1, wherein:
the identifying at least one pattern in the movement of the mobile device includes identifying at least one series of locations which is repeatedly visited.

6. The processor-implemented method of claim 1, wherein:
the user interface settings of the mobile device are stored at the different times at which the electromagnetic radiation is sensed at the different locations.

7. The processor-implemented method of claim 1, wherein:
the user interface settings of the mobile device are stored at times other than the different times at which the electromagnetic radiation is sensed at the different locations.

8. The processor-implemented method of claim 1, wherein:
the electromagnetic radiation is emitted by devices present at the locations.

9. A processor-implemented method for controlling a context-aware mobile device which communicates by wireless signals, comprising:
for each location of multiple locations which the mobile device visits: sensing, at the mobile device, electromagnetic radiation at each location, identifying a signature of the electromagnetic radiation, determining at least one user-configured user interface setting of the mobile device, and storing the signature of the electromagnetic radiation cross-referenced to the at least one user-configured user interface setting;
based on the storing, identifying locations of the multiple locations which the mobile device repeatedly visits; and
for at least one location which the mobile device repeatedly visits, automatically, without user intervention, modifying a user interface setting of the mobile device when it is determined that the mobile device visits the at least one location an additional time.

10. The processor-implemented method of claim 9, wherein:
for at least one location of the multiple locations, the electromagnetic radiation which is sensed is a wireless radio frequency transmission from an access point of a wireless local area network.

11. The processor-implemented method of claim 9, wherein:
for at least one location of the multiple locations, the electromagnetic radiation which is sensed is a wireless radio frequency transmission from a client device in a wireless local area network.

12. The processor-implemented method of claim 9, wherein:
for at least one location of the multiple locations, the mobile device repeatedly senses electromagnetic radiation and identifies the signature of the electromagnetic radiation less often as it is determined that the mobile device remains at the at least one location of the multiple locations.

13. The processor-implemented method of claim 9, further comprising:
determining when the mobile device leaves a location of the multiple locations by the mobile device no longer sensing electromagnetic radiation at the location of the multiple locations, in response to which the mobile device attempts to sense electromagnetic radiation more often.

14. The processor-implemented method of claim 9, further comprising:
determining when the mobile device has been stationary in a location of the multiple locations, and determining when the mobile device is subsequently in motion using a motion sensor of the mobile device, in response to which the mobile device automatically modifies a user interface setting of the mobile device.

15. The processor-implemented method of claim 9, further comprising:
for at least one location of the multiple locations which the mobile device repeatedly visits, determining associated times of the visits, in response to which the mobile device automatically provides a label for the at least one location in a user interface setting of the mobile device.

16. The processor-implemented method of claim 9, further comprising:
for at least one location of the multiple locations which the mobile device repeatedly visits at least a threshold number of times, prompting the user to provide a label for the at least one location in a user interface setting of the mobile device.

17. The processor-implemented method of claim 9, further comprising:
for at least one location of the multiple locations which the mobile device repeatedly visits with at least a threshold frequency, prompting the user to provide a label for the at least one location in a user interface setting of the mobile device.

18. A context-aware mobile device which communicates by wireless signals, comprising:
an electromagnetic radiation sensor;
a movement sensor;
a user interface which provides a notification to the user;
memory which stores processor-readable code; and
at least one processor which executes the processor-readable code, the at least one processor causes the electromagnetic radiation sensor to attempt to sense electromagnetic radiation until a presence of electromagnetic radiation is confirmed, once the presence of electromagnetic radiation is confirmed, detects a signature of the electromagnetic radiation, and identifies a first notification behavior to be implemented by the user interface based on the signature by accessing a list of electromagnetic radiation signatures cross-referenced to notification behaviors, responsive to identifying the first notification behavior, changes the user interface to implement the first notification behavior, receives an indication from the movement sensor that movement of the mobile device is detected, and in response to the indication, changes the user interface to implement another notification behavior in place of the first notification behavior.

19. The context-aware mobile device of claim 18, wherein:
when the user interface changes to implement the first notification behavior, the at least one processor implements the first notification behavior in place of the another notification behavior.

20. The context-aware mobile device of claim 18, wherein:
the at least one processor changes the user interface to implement the first notification behavior is responsive to an indication from the movement sensor that movement of the mobile device has not been detected for a predetermined period of time after the presence of electromagnetic radiation is confirmed.
